(19) United States
(12) Patent Application Publication
(10) Pub. No.: US 2026/0276212 A1
(43) Pub. Date: Sep. 17, 2026

(54) SYSTEM AND METHOD FOR CENTRALIZED STEAM CLEANING

(71) Applicant: Clean Core LLC, Hillsboro, OR (US)

(72) Inventors: Sean Blanchard, Hillsboro, OR (US); Daniel Blexrude, Portland, OR (US)

(73) Assignee: Clean Core LLC, Hillsboro, OR (US)

(21) Appl. No.: 19/672,010

(22) Filed: May 8, 2026

Related U.S. Application Data
(63) Continuation-in-part of application No. 18/521,165, filed on Nov. 28, 2023, now Pat. No. 12,622,564.
(60) Provisional application No. 63/429,900, filed on Dec. 2, 2022.

(51) Int. Cl. F24D 1/00; B08B 3/00

(52) U.S. Cl. CPC F24D 1/00; B08B 3/00

(57) ABSTRACT

Certain examples of the disclosure concern a centralized steam cleaning system which includes a central control unit and a pipe network distributed within a building. The pipe network can include a vacuum pipeline and a water pipeline extending alongside each other.

### CROSS-REFERENCE TO RELATED APPLICATIONS

This is a continuation-in-part of patent application U.S. Patent Application No. 18/521,165, filed Nov. 28, 2023, which claims the benefit of U.S. Provisional Application No. 63/429,900, filed Dec. 2, 2022, all of which applications are incorporated by reference herein.

### FIELD

The present disclosure concerns systems and methods related to centralized steam cleaning, including centralized steam cleaning systems distributed across one or more interior and/or exterior areas of a building.

### BACKGROUND

Steam cleaning involves using steam or vapor for cleaning, and can be used for cleaning carpet, tile and grout, upholstery, etc. However, steam cleaning can be laborious and time consuming, especially for high rise buildings that include numerous rooms on multiple floors. Using a portable steam cleaner to clean multiple rooms is generally inefficient. Using an industrial steam cleaning machine (e.g., a truck mount carpet cleaning machine) with extendable hoses to clean a building is also limited by many factors, such as the height of the building, the floor plan of individual rooms, etc. The complexity and length of operation also lead to increased costs. Similar inefficiencies can arise in exterior areas associated with buildings, such as parking lots, vehicle service areas, and/or other outdoor cleaning areas. For example, cleaning carpets, upholstery, floor mats, and/or other interior surfaces of vehicles can require portable equipment, long hoses, or separate steam and vacuum devices. Such arrangements can be inefficient, may require repeated movement of equipment between vehicles, and may be difficult to control or meter for commercial use. Thus, there exists a need for improved steam cleaning techniques that can be used in interior and/or exterior areas associated with buildings.

### SUMMARY

Described herein are apparatuses, systems, and methods for centralized steam cleaning in one or more areas of a building, including interior areas of the building and/or exterior areas associated with the building, which overcome one or more of the deficiencies of state-of-the-art steam cleaning technologies.

In some aspects, the techniques described herein relate to a centralized steam cleaning system including: a central control unit; and a pipe network connected to the central control unit, wherein the pipe network is configured to be distributed within a building, wherein the pipe network includes a vacuum pipeline and a water pipeline that extend alongside each other, wherein the central control unit is configured to generate a negative pressure for air within the vacuum pipeline and a water steam within the water pipeline.

In some aspects, the techniques described herein relate to a centralized steam cleaning system, wherein the negative pressure is between 6 psi and 9 psi, wherein the water steam has a temperature ranging between 200- and 240-degree Fahrenheit.

In some aspects, the techniques described herein relate to a centralized steam cleaning system, further including a plurality of ports connected to the pipe network, wherein each port includes an outlet of the water pipeline and an outlet of the vacuum pipeline.

In some aspects, the techniques described herein relate to a centralized steam cleaning system, wherein the plurality of ports includes one or more floor ports configured to be located at corresponding floors of the building, wherein each floor port includes a housing enclosing the outlet of the water pipeline and the outlet of the vacuum pipeline, wherein the water pipeline and the vacuum pipeline extend from a first side of the housing to a second side of the housing.

In some aspects, the techniques described herein relate to a centralized steam cleaning system, wherein each floor port includes an air valve and a water valve enclosed within the housing, wherein the air valve is configured to enable or disable the air within the vacuum pipeline to flow from the first side of the housing to the second side of the housing, wherein the water valve is configured to enable or disable the water steam within the water pipeline to flow from the first side of the housing to the second side of the housing.

In some aspects, the techniques described herein relate to a centralized steam cleaning system, wherein the plurality of ports includes one or more room ports configured to be located within corresponding rooms of the building, wherein each room port includes a housing enclosing the outlet of the water pipeline and the outlet of the vacuum pipeline, wherein the water pipeline and the vacuum pipeline extend into the housing and do not exit from the housing.

In some aspects, the techniques described herein relate to a centralized steam cleaning system, wherein each room port includes a water valve enclosed within the housing, wherein the water valve is configured to enable or disable the water steam within the water pipeline to flow through the outlet of the water pipeline.

In some aspects, the techniques described herein relate to a centralized steam cleaning system, further including a hose assembly, wherein the hose assembly includes a water hose and a vacuum hose, wherein the water hose is configured to be releasably connected to the outlet of the water pipeline, wherein the vacuum hose is configured to be releasably connected to the outlet of the vacuum pipeline.

In some aspects, the techniques described herein relate to a centralized steam cleaning system, wherein the outlet of the water pipeline includes a seal configured to block the water steam within the water pipeline from escaping through the outlet of the water pipeline, wherein connecting the water hose to the outlet of the water pipeline is configured to displace the seal so as to enable the water steam within the water pipeline to escape through the outlet of the water pipeline.

In some aspects, the techniques described herein relate to a centralized steam cleaning system, further including at least one portable cleaning device, wherein the portable cleaning device includes a water channel and a vacuum channel, wherein the water channel is configured to be releasably connected to the water hose, wherein the vacuum channel is configured to be releasably connected to the vacuum hose.

In some aspects, the techniques described herein relate to a centralized steam cleaning system including: a pipe network configured to be distributed within a building, wherein the pipe network includes a vacuum pipeline and a water pipeline that extend alongside each other; and a plurality of ports connected to the pipe network, wherein each port includes an outlet of the water pipeline and an outlet of the vacuum pipeline, wherein the water pipeline is configured to allow a water steam to flow therethrough, wherein the vacuum pipeline is configured to allow an air under negative pressure to flow therethrough.

In some aspects, the techniques described herein relate to a centralized steam cleaning system, further including a central control unit configured to generate the negative pressure for the air within the vacuum pipeline and the water steam within the water pipeline.

In some aspects, the techniques described herein relate to a centralized steam cleaning system, further including a hose assembly, wherein the hose assembly includes a water hose and a vacuum hose that are bundled together, wherein the water hose is configured to be releasably connected to the outlet of the water pipeline, wherein the vacuum hose is configured to be releasably connected to the outlet of the vacuum pipeline.

In some aspects, the techniques described herein relate to a centralized steam cleaning system, further including at least one portable cleaning device, wherein the portable cleaning device includes a wand, a cleaning head connected to a distal end of the wand, a water channel, and a vacuum channel, wherein the water channel and the vacuum channel extend through a lumen of the wand and into the cleaning head, wherein the water channel is configured to be releasably connected to the water hose, wherein the vacuum channel is configured to be releasably connected to the vacuum hose.

In some aspects, the techniques described herein relate to a centralized steam cleaning system, wherein the plurality of ports includes one or more floor ports, wherein each floor port includes a floor port casing enclosing the outlet of the water pipeline and the outlet of the vacuum pipeline, wherein the water pipeline and the vacuum pipeline extend through the floor port casing.

In some aspects, the techniques described herein relate to a centralized steam cleaning system, wherein the plurality of ports includes one or more room ports, wherein each room port includes a room port casing enclosing the outlet of the water pipeline and the outlet of the vacuum pipeline, wherein the water pipeline and the vacuum pipeline extend into the room port casing and do not exit from the room port casing.

In some aspects, the techniques described herein relate to a method for steam cleaning a building, the method including: generating a negative air pressure within a vacuum pipeline; generating a water steam within a water pipeline; releasing the water steam from the water pipeline to a selected area within the building; and vacuuming the selected area by applying the negative air pressure within the vacuum pipeline, wherein the water pipeline and the vacuum pipeline extend alongside each other and form a pipe network distributed within the building.

In some aspects, the techniques described herein relate to a method, further including opening a housing enclosing an outlet of the water pipeline and an outlet of the vacuum pipeline, wherein releasing the water steam includes connecting a water hose to the outlet of the water pipeline, wherein the vacuuming includes connecting a vacuum hose to the outlet of the vacuum pipeline.

In some aspects, the techniques described herein relate to a method, wherein releasing the water steam further includes connecting a water channel to the water hose, wherein the vacuuming further includes connecting a vacuum channel to the vacuum hose, wherein the water channel and the vacuum channel extend through a wand a portable cleaning device.

In some aspects, the techniques described herein relate to a method, further including disabling flow of the water steam within at least a portion of the water pipeline so as to reduce water pressure at the outlet of the water pipeline before connecting the water hose to the outlet of the water pipeline.

In some examples, the pipe network can be distributed within the building, outside the building, or both within and outside the building. For example, the pipe network can extend through walls, floors, ceilings, hallways, rooms, or other interior portions of the building. In other examples, the pipe network can extend along an exterior of the building, across a parking lot, through a vehicle cleaning area, along one or more support posts, and/or through one or more exterior manifolds or conduits.

Certain aspects of the disclosure further concern a centralized steam cleaning system comprising: a central control unit; a pipe network connected to the central control unit; and a plurality of access ports connected to the pipe network, wherein the pipe network is distributed across one or more areas of a building, wherein the pipe network comprises a vacuum pipeline and a water pipeline that extend alongside each other, wherein the central control unit is configured to generate a negative pressure for air within the vacuum pipeline and a water steam within the water pipeline, wherein each access port comprises an outlet of the water pipeline and an outlet of the vacuum pipeline, wherein each access port comprises a housing enclosing the outlet of the water pipeline and the outlet of the vacuum pipeline.

Certain aspects of the disclosure further concern a centralized steam cleaning system comprising: a pipe network distributed across one or more areas of a building, wherein the pipe network comprises a vacuum pipeline and a water pipeline that extend alongside each other; and a plurality of access ports connected to the pipe network, wherein each access port comprises an outlet of the water pipeline and an outlet of the vacuum pipeline, wherein the water pipeline is configured to allow a water steam to flow therethrough, wherein the vacuum pipeline is configured to allow air under negative pressure to flow therethrough, wherein the plurality of access ports comprises one or more pass-through access ports, wherein each pass-through access port comprises a housing enclosing the outlet of the water pipeline and the outlet of the vacuum pipeline, and wherein the water pipeline and the vacuum pipeline extend through the housing of each pass-through access port.

Certain aspects of the disclosure further concern a method comprising: causing water steam to flow through a water pipeline of a pipe network distributed across one or more areas of a building; causing air under negative pressure to flow through a vacuum pipeline of the pipe network, wherein the vacuum pipeline and the water pipeline extend alongside each other; enabling flow of the water steam through an outlet of the water pipeline at an access port connected to the pipe network; enabling application of the air under negative pressure through an outlet of the vacuum pipeline at the access port; releasing the water steam from the outlet of the water pipeline toward a target area; and applying the air under negative pressure from the outlet of the vacuum pipeline to the target area, wherein the access port comprises a housing enclosing the outlet of the water pipeline and the outlet of the vacuum pipeline.

The foregoing and other features and advantages of the disclosed technologies will become more apparent from the following detailed description, which proceeds with reference to the accompanying figures.

### BRIEF DESCRIPTION OF THE DRAWINGS

FIG. 1 schematically depicts an example centralized steam cleaning system that can be used in a building.

FIG. 2 schematically depicts the distribution of pipe network of the centralized steam cleaning system of FIG. 1 on a floor of a building.

FIG. 3 is a perspective view of a floor port of the centralized steam cleaning system of FIG. 1, according to one example.

FIG. 4A is a perspective view of a room port of the centralized steam cleaning system of FIG. 1, according to one example.

FIG. 4B is a top view of the room port of FIG. 4A.

FIG. 5 is a perspective view of a central control unit of the centralized steam cleaning system of FIG. 1, according to one example.

FIG. 6 is a block diagram of the central control unit of FIG. 5, according to one example.

FIG. 7A depicts a hose assembly that can be used in conjunction with the centralized steam cleaning system of FIG. 1, according to one example.

FIG. 7B depicts an example water adaptor included in the floor port of FIG. 3 and/or room port of FIG. 4A.

FIG. 7C depicts an example end of a water hose included in the hose assembly of FIG. 7A.

FIG. 8 depicts a portable cleaning device that can be used in conjunction with the centralized steam cleaning system of FIG. 1, according to one example.

FIG. 9 depicts an example centralized steam cleaning system including an exterior manifold and exterior access ports located outside a building.

### DETAILED DESCRIPTION

### General Considerations

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved. The technologies from any example can be combined with the technologies described in any one or more of the other examples. In view of the many possible examples to which the principles of the disclosed technology may be applied, it should be recognized that the illustrated examples are only preferred examples and should not be taken as limiting the scope of the disclosed technology.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art. Any theories of operation are to facilitate explanation, but the disclosed systems, methods, and apparatus are not limited to such theories of operation.

As used in this application and in the claims, the singular forms “a,” “an,” and “the” include the plural forms unless the context clearly dictates otherwise. Additionally, the term “includes” means “comprises.” Further, the terms “coupled” and “connected” generally mean electrically, electromagnetically, and/or physically (e.g., mechanically or chemically) coupled or linked and does not exclude the presence of intermediate elements between the coupled or associated items absent specific contrary language. As used herein, a “building” can include a residential, commercial, industrial, or other structure. References to “one or more areas of a building” can include interior areas of the building and/or exterior areas associated with the building, such as interior rooms, hallways, floors, exterior walls, parking lots, driveways, vehicle service areas, walkways, or other areas associated with use of the building.

Directions and other relative references (e.g., inner, outer, upper, lower, etc.) may be used to facilitate discussion of the drawings and principles herein, but are not intended to be limiting. For example, certain terms may be used such as “inside,” “outside,” “interior,” “exterior,” and the like. Such terms are used, where applicable, to provide some clarity of description when dealing with relative relationships, particularly with respect to the illustrated examples. Such terms are not, however, intended to imply absolute relationships, positions, and/or orientations. For example, with respect to an object, an “upper” part can become a “lower” part simply by turning the object over. Nevertheless, it is still the same part and the object remains the same. As used herein, “and/or” means “and” or “or,” as well as “and” and “or.”

### Example Central Steam Cleaning System

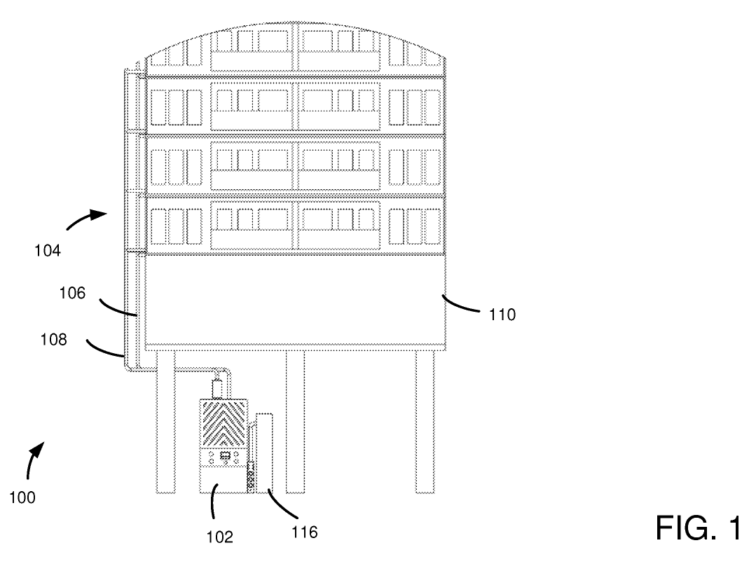

FIG. 1 depicts an example central steam cleaning system 100 that can be used in a building 110. In the depicted example, the building 110 has multiple floors. In other examples, the building 110 can have only a single floor.

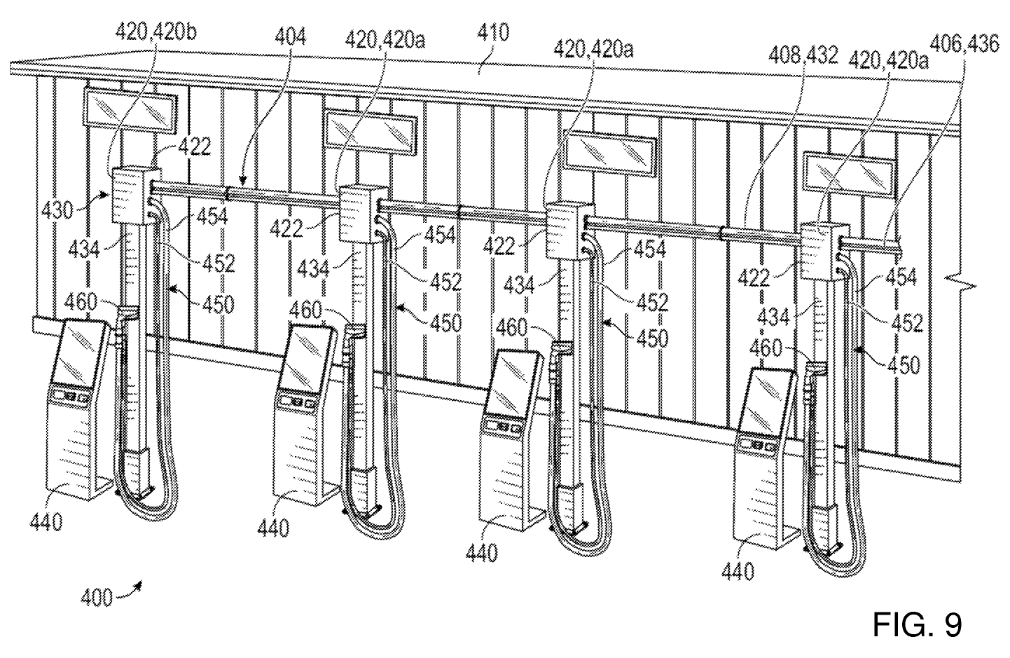

The central steam cleaning system 100 includes a central control unit 102 which is fluidly connected to a water reserve 116. The central steam cleaning system 100 also includes a pipe network 104 distributed across one or more areas of the building 110. In the example shown in FIG. 1, the pipe network 104 is distributed within the building 110, such as through dry walls, floors, ceilings, and/or other constructs of the building. As described further below with reference to FIG. 9, in other examples, at least a portion of the pipe network can be distributed outside the building, such as along an exterior area, a parking lot, a vehicle service area, or another area associated with the building. The pipe network 104 can extend to areas of the building 110, including interior and/or exterior areas, that need cleaning. As shown, the pipe network 104 includes a water pipeline 106 and a vacuum pipeline 108 that run in parallel to each other. As described herein, two pipelines (or channels) are deemed to run in parallel if they are arranged side by side (i.e., extend alongside each other), running in the same direction without intersecting each other and maintaining a consistent separation throughout their length. In the depicted example, the central control unit 102 is located at the lowest level of the building 110. In other examples, the central control unit 102 can be located in the basement or higher-level floors of the building.

In some instances, the building 110 (e.g., when the building 110 is a skyscraper having many floors) can be installed with multiple central steam cleaning systems 100, each having its own central control unit 102 and corresponding pipe network 104. The central steam cleaning systems 100 can work independently, each being used for cleaning of designated areas (e.g., multiple floors) of the buildings.

The central control unit 102 can be configured to generate a negative pressure within the vacuum pipeline 108. As described herein, a negative pressure means a pressure that is below the atmospheric (or ambient) pressure. The central control unit 102 can also be configured to generate a hot water steam within the water pipeline 106. Details of examples of the central control unit 102 are described more fully below.

In some examples, the generated negative pressure can be in the range of 0 - 14 psi, or 6 psi - 9 psi. In one specific example, the generated negative pressure can be about 10%-50% about the atmospheric pressure.

In some examples, the generated temperature of the water steam can be in the range of 175 - 250 degrees Fahrenheit, or 200 - 240 degrees Fahrenheit. In one specific example, the temperature of the water steam can be about 230 degrees Fahrenheit.

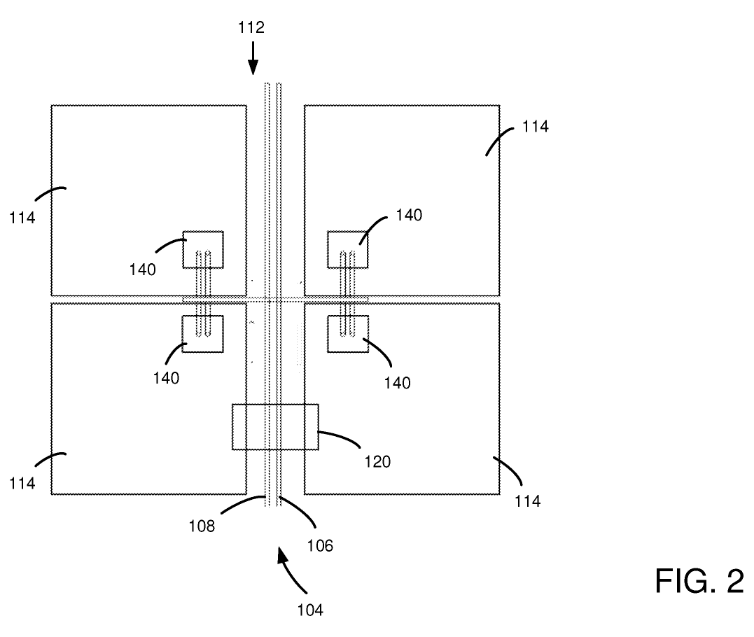

FIG. 2 shows branching of the pipe network 104 on one floor of the building 110, according to one interior example. As shown, the floor can have multiple rooms 114 and one or more hallways 112 (or aisles) extending between some of the rooms. The pipe network 104, which includes the vacuum pipeline 108 and the water pipeline 106, can extend along the hallways 112 and into the rooms 114. Both the vacuum pipeline 108 and the water pipeline 106 can form branches, e.g., by using connectors. For example, a tee connector can be used to split one pipe into two, directing air and/or water steam flow to multiple locations; an elbow connector enables pipes to make 90-degree turns and facilitates changes in direction; a Y-shaped fitting can create a branch by diverting air and/or water steam from a single source into two separate directions. In some examples, only areas of the building that requires steam cleaning services are supplied with the vacuum pipeline 108 and the water pipeline 106. In some examples, the routes for installing the pipe network 104 can be optimized to reduce the overall length of the pipes. In some interior examples, the pipes of the pipe network 104, including the vacuum pipeline 108 and the water pipeline 106, can be concealed from users, such as behind drywall, under a floor, above a ceiling, or in another interior structure. In other examples, such as exterior examples, at least a portion of the pipe network can be exposed, partially exposed, mounted to a support structure, and/or otherwise routed outside the building.

In some examples, the central steam cleaning system 100 can include a plurality of ports connected to the pipe network 104. The ports can also be referred to herein as “access ports.” Each access port can include an outlet of the water pipeline 106 and an outlet of the vacuum pipeline 108. An access port can include any port, casing, enclosure, cabinet, housing, or other interface through which a user, hose assembly, cleaning device, or control system can access the water pipeline 106 and the vacuum pipeline 108. Thus, access ports can include, for example, floor ports, room ports, exterior ports, pass-through access ports, terminal access ports, or combinations thereof. For example, FIG. 2 shows a floor port 120 and four room ports 140. Each room port 140 can be located in one of the rooms 114 that needs cleaning services. In some examples, each floor port 120 can be located in a corresponding floor of the building that needs cleaning services. A pass-through access port refers to an access port in which the water pipeline 106 and the vacuum pipeline 108 extend through a housing of the access port. A terminal access port refers to an access port in which the water pipeline 106 and the vacuum pipeline 108 extend into a housing of the access port and do not exit from the housing. A floor port 120 can be an example of a pass-through access port, and a room port 140 can be an example of a terminal access port. As described below, each floor port 120 can have an air valve and a water valve configured to turn on or off the air flow and/or water steam flow within the vacuum pipeline 108 and water pipeline 106 at corresponding floors of the building, respectively. As described with reference to FIG. 9, an exterior port can also be configured as a pass-through access port or a terminal access port.

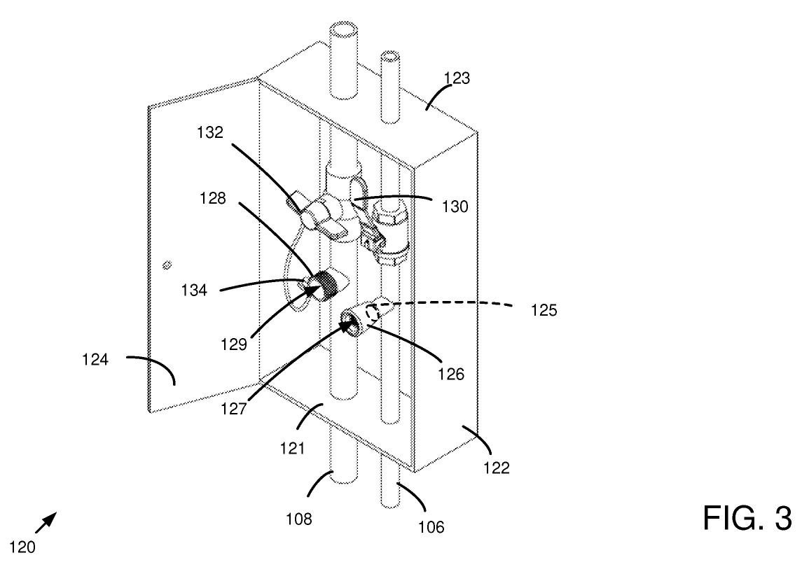

FIG. 3 shows an example floor port 120, which can be mounted on a side wall of a hallway or other locations on a floor of the building. The floor port 120 can include a housing 122 (e.g., a cabinet, or the like). The housing 122 can have a cover or door 124, which can be locked or unlocked by an operator of the central steam cleaning system 100. The housing 122 can also be referred to as a “floor port casing.” In some examples, the floor port 120 can also be referred to as an access port or a pass-through access port.

The pipe network 104 can extend through the housing 122. For example, the vacuum pipeline 108 and water pipeline 106 can enter the housing 122 from one side 121 of the housing 122 and exit the housing 122 from an opposite side 123 of the housing 122.

The floor port 120 can have a water valve 130 connected to the water pipeline 106 and an air valve 132 connected to the vacuum pipeline 108. The operator can turn ON or OFF the air valve 132 and/or the water valve 130. The water valve 130 and the air valve 132 are located within the housing 122.

When the water valve 130 is turned to an ON position, water steam is allowed to pass through the portion of the water pipeline 106 between the side 121 and side 123. When the water valve 130 is turned to an OFF position, water steam is blocked from passing through the portion of the water pipeline 106 between the side 121 and side 123.

Similarly, when the air valve 132 is turned to an ON position, air is allowed to flow through the portion of the vacuum pipeline 108 between the side 121 and side 123. When the air valve 132 is turned to an OFF position, air is blocked from flowing through the portion of the vacuum pipeline 108 between the side 121 and side 123.

In certain examples, the operator can turn off both the air valves 132 and water valves 130 in the floor ports 120 of selected floors. That will shut off both air flow and water steam flow in the pipe network 104 for those selected floors. Such selected shut-off can be used to increase the negative pressure and water pressure in other floors (e.g., by pausing air flow and water steam flow in the selected floors).

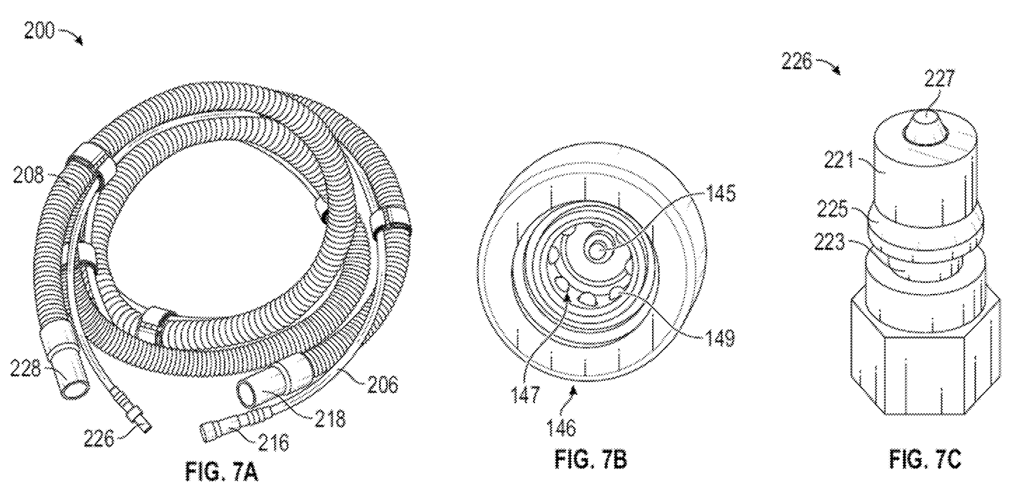

As shown in FIG. 3, the floor port 120 can have a water adaptor 126 connected to the water pipeline 106 and an air adaptor 128 connected to the vacuum pipeline 108. The water adaptor 126 defines an outlet of the water pipeline 106 and the air adaptor 128 defines an outlet of the vacuum pipeline 108 at the floor port 120. Both the water adaptor 126 and the air adaptor 128 can be located within the housing 122. The water adaptor 126 and the air adaptor 128 can be connected to certain accessories of the central steam cleaning system 100, such as a hose assembly 200 (including a water hose 206 and a vacuum hose 208) depicted in FIG. 7A and described further below.

The water adaptor 126 has a lumen 127 which can fluidly communicate with the portion of the water pipeline 106 located between the side 121 and side 123. In some examples, the water adaptor 126 can have an inner seal 125 configured to block the water or water steam in the water pipeline 106 from flowing out of the water adaptor 126 through the lumen 127. As described below, when connected to the water hose 206, the seal 125 can be displaced so as to allow the water or water steam in the water pipeline 106 to flow into the water hose 206 through the lumen 127 of the water adaptor 126.

In certain examples, before connecting the water hose 206 to the water adaptor 126, the water valve 130 is first turned to the OFF position to shut off water steam flow through the portion of the water pipeline 106 located between the side 121 and side 123. This can reduce the water pressure at the water adaptor 126 so that it has less resistance and makes it easier for the operator to connect the water hose 206 to the water adaptor 126.

The air adaptor 128 has a lumen 129 which can fluidly communicate with the portion of the vacuum pipeline 108 located between the side 121 and side 123. In some examples, the air adaptor 128 can have a cap 134. When not in use, the lumen 129 of the air adaptor 128 can be covered by the cap 134. The cap 134 can be removed for connecting to the vacuum hose 208, as described further below.

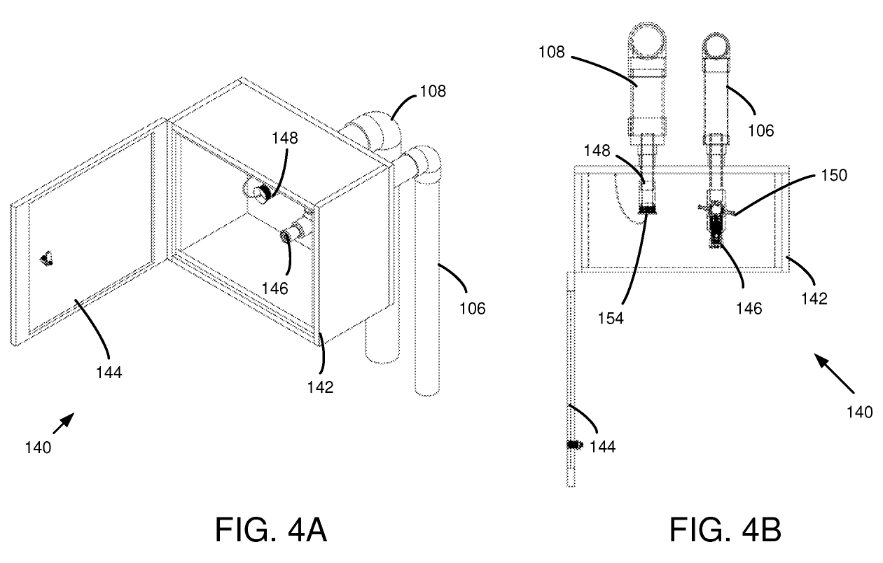

FIGS. 4A-4B depict an example room port 140, which can be mounted on a side wall or other locations within a room. Similar to the floor port 120, the room port 140 can include a housing 142 (e.g., a cabinet, or the like). The housing 142 can have a cover or door 144, which can be locked or unlocked by the operator of the central steam cleaning system 100. The housing 142 can also be referred to as a “room port casing.” In some examples, the room port 140 can also be referred to as an access port or a terminal access port.

The pipe network 104 can have a terminal interface with the housing 142. For example, the vacuum pipeline 108 and water pipeline 106 can enter the housing 142 from a back side of the housing 142. Unlike the floor port 120 wherein the vacuum pipeline 108 and water pipeline 106 enter from one side of the housing 121 and exit from another side 123 of the housing 122, each room port 140 represents a terminal end for a branch of the pipe network 104 because the vacuum pipeline 108 and water pipeline 106 do not exit from the housing 142.

As shown, the room port 140 can have a water adaptor 146 (similar to 126) connected to the water pipeline 106 and an air adaptor 148 (similar to 128) connected to the vacuum pipeline 108. The water adaptor 146 defines an outlet of the water pipeline 106 and the air adaptor 148 defines an outlet of the vacuum pipeline 108 at the room port 140. Both the water adaptor 146 and the air adaptor 148 are located within the housing 142. Likewise, the water adaptor 126 and the air adaptor 128 can be connected to certain accessories of the central steam cleaning system 100, such as a hose assembly 200 depicted in FIG. 7A and described further below.

Similar to 126, the water adaptor 146 has a lumen which can fluidly communicate with the water pipeline 106. The water adaptor 146 can also have an inner seal (similar to 125) configured to block the water or water steam in the water pipeline 106 from flowing into the lumen off the water adaptor 146. When connected to the water hose 206, such seal can be displaced so as to allow the water or water steam in the water pipeline 106 to flow into the water hose 206 through the lumen of the water adaptor 146.

Additionally, the water adaptor 146 can have a water valve 150 which can be turned ON or OFF. The water valve 150 can be located within the housing 142. Turning the water valve 150 to the ON position allows the water or water steam to flow through the lumen of the water adaptor 146, while turning the water valve 150 to the OFF position blocks the lumen within the water adaptor 146. In some examples, the water valve 150 can be positioned distal to the inner seal (i.e., farther away from the opening of the water adaptor 146). Thus, even if the inner seal of the water adaptor 146 is displaced (e.g., by connecting the water hose 206 to the water adaptor 146), the water valve 150 can still prevent water or water steam in the water pipeline 106 from entering the lumen of the water adaptor 146.

In certain examples, before connecting the water hose 206 to the water adaptor 146, the water valve 150 is first turned to the OFF position. This can reduce the water pressure at the water adaptor 146 so that it has less resistance and makes it easier for the operator to connect the water hose 206 to the water adaptor 146.

Similar to 128, the air adaptor 148 has a lumen which can fluidly communicate with the vacuum pipeline 108. A cap 154 can be used to cover or expose the lumen of the air adaptor 148.

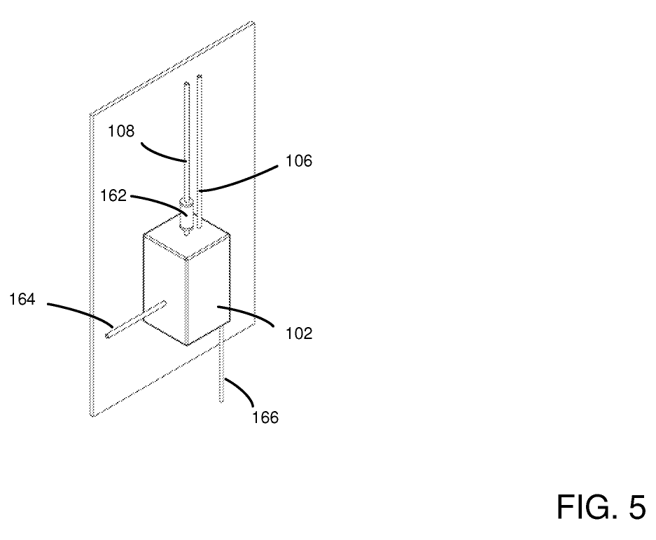

FIG. 5 depicts an example central control unit 102 and its external connections. The central control unit 102 can be attached to a floor or other structure of the building. As shown, both the water pipeline 106 and the vacuum pipeline 108 are connected to the central control unit 102. In some examples, a debris filter 162 can be mounted on the vacuum pipeline 108. The debris filter 162, which can be replaced, can be configured to filter out debris in the vacuum pipeline 108.

In some examples, an exhaust pipe 164 can be connected to the central control unit 102. The exhaust pipe 164 can allow exhaust gas generated by the central steam cleaning system 100 to escape therethrough.

In some examples, the central control unit 102 can also be connected to a sewage pipe 166, which is configured to discharge dirty water or solution to a sewage system of the building.

In some examples, a water source, e.g., a water tank can be enclosed within the central control unit 102. In some examples, the water source can be external to the central control unit 102, such as the water reserve 116 depicted in FIG. 1.

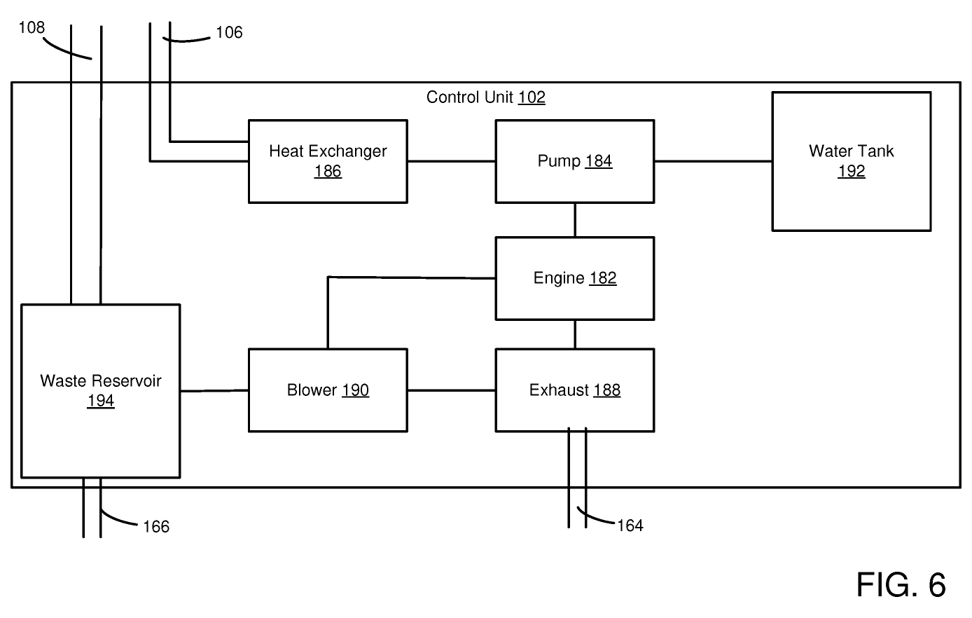

FIG. 6 depicts a block diagram of the central control unit 102, according to one example. In the depicted example, the central control unit 102 can include an engine or motor 182, a water pump 184, a heat exchanger 186, an exhaust chamber 188, a blower 190, a water tank 192, and a waste reservoir 194.

The engine 182 can generate electricity to power the water pump 184, which receives clean water from the water tank 192. The pumped water can pass through the heat exchanger 186 where the water is heated (e.g., up to a boiling temperature) so as to generate a flow of water steam into the water pipeline 106. In some examples, certain detergent(s), sanitizer(s), disinfectant(s) and/or other cleaning solutions can be added to the water tank so that the generated water steam can comprise molecules of those additives.

The engine 182 can also power the blower 190 which can blow air into the exhaust chamber and further out of the control unit 102 through the exhaust pipe 164. By blowing the air, a negative pressure or vacuum can be created in the waste reservoir 194 and the vacuum pipeline 108 connected thereto. The negative pressure can suck the air, dirt, and water collected in the vacuum pipeline 108 into the waste reservoir 194. The waste (e.g., the dirt or dirty water) deposited in the waste reservoir 194 can be discharged into a sewage system of the building through the sewage pipe 166.

### Example Accessories

Some accessories can be configured to work in conjunction with the central steam cleaning system 100 described above. In some circumstances, any of the accessories described herein can also be considered part of the central steam cleaning system 100.

FIGS. 7A depicts a hose assembly 200 that can be used in conjunction with (or be part of) the central steam cleaning system 100, according to one example. The hose assembly 200 can include a water hose 206 and a vacuum hose 208. The water hose 206 and the vacuum hose 208 can have about the same length and extend alongside each other. In some examples, the water hose 206 and the vacuum hose 208 can be bundled together. The length of the water hose 206 and the vacuum hose 208 can be customized (e.g., 10 feet, 20 feet, 50 feet, 100 feet, etc.) for different uses. In some examples, the water hose 206 and/or the vacuum hose 208 can comprise heavy duty kink free materials.

The vacuum hose 208 includes a first end 218 and a second end 228 opposite to the first end 218. The second end 228 can be releasably connected to the air adaptor 128 of the floor port 120 or the air adaptor 148 of the room port 140 described above (e.g., after removing the cap 134 or 154). The first end 218 is configured to be releasably connected to a portable cleaning device (e.g., 300) described further below.

In certain examples, the second end 228 can have internal threads that are configured to threadably mate with external threads of the air adaptor 128 or 148. In such case, the air adaptor 128 or 148 (acting as a male component) can be inserted into a lumen of the second end 228 (acting as a female component). In other examples, the second end 228 can be configured as the male component and the air adaptor 128 or 148 can be configured as the female component. Other coupling mechanisms (e.g., snap fit, interlocking grooves, inference fit, etc.) can be used to connect the second end 228 to the air adaptor 128 or 148.

The water hose 206 includes a first end 216 and a second end 226 opposite to the first end 216. The second end 226 can be releasably connected to the water adaptor 126 of the floor port 120 or the water adaptor 146 of the room port 140 described above. The first end 216 is configured to be releasably connected to a portable cleaning device (e.g., 300) described further below.

FIG. 7B shows an example internal structure of a water adaptor 146 (and the water adaptor 126 can have similar structure) and FIG. 7C shows an example second end 226 of the water hose 206. It is to be understood that the water adaptor 146 and the second end 226 can have other complimentary structures to allow them to be securely and releasably coupled together.

As shown in FIGS. 7B-7C, the second end 226 has a head portion 221 configured to be inserted into a lumen 147 of the water adaptor 146. The second end 226 has a distal tip 227 extending from a distal end of the head portion 221, a flange 225 projecting radially outwardly from the head portion 221, and a neck portion 223 having a smaller diameter than the flange 225. The neck portion 223 and the distal tip 227 are located on opposite sides of the flange 225. The water adaptor 146 can include a plurality of ball bearings 149 distributed around an inner wall defining the lumen 147. When inserting the head portion 221 into the lumen 147, the flange 225 can push the ball bearings 149 radially outwardly. After pushing the head portion 221 into the lumen 147, the ball bearings 149 can pop radially inwardly (e.g., through a biased spring mechanism) and received within the neck portion 223, thereby securely locking the second end 226 with the water adaptor 146. To disconnect, the second end 226 can be pulled away from the water adaptor 146 using a sufficiently large force that overcomes the resistance of the ball bearings 149 against the flange 225.

The base of the water adaptor 146 can have a nipple 145 which is connected to the inner seal (similar to 125) of the water adaptor 146. The nipple 145 can be coupled to a biasing mechanism (e.g., a spring) and movable between a resting state and a biased state. At the resting state, the biasing mechanism can push the nipple 145 toward the opening of the lumen 147, at which position the inner seal is configured to prevent water or water steam in the water pipeline 106 from flowing out of the water adaptor 146 through the lumen 147. After connecting the second end 226 to the water adaptor 146, the distal tip 227 of the second end 226 can push the nipple 145 in a distal direction (i.e., away from the opening of the lumen 147) to the biased state. The displacement of the nipple 145 from its resting state to the biased state can cause the corresponding movement of the inner seal, thereby allowing the water or water steam in the water pipeline 106 to flow into the lumen 147 of the water adaptor 146.

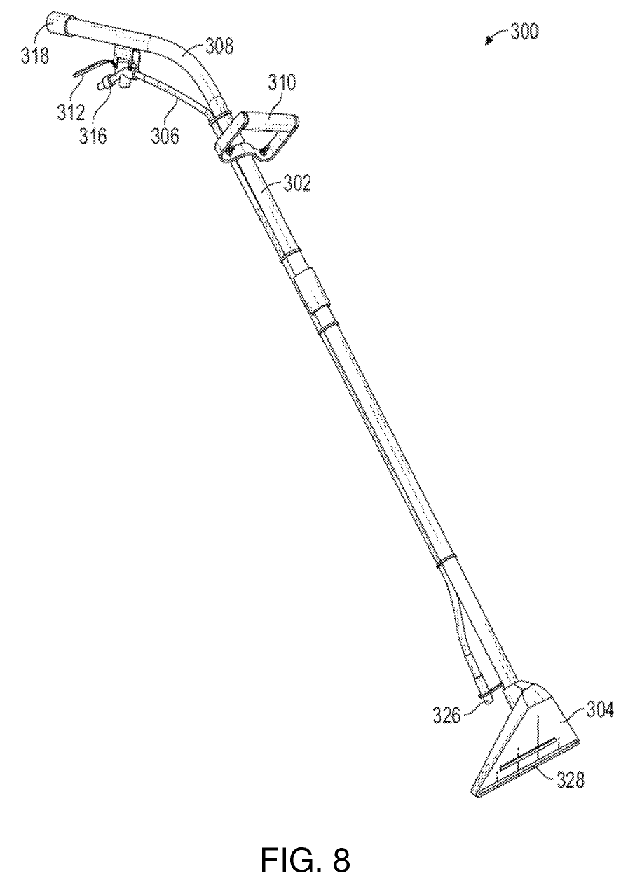

FIG. 8 depicts an example portable cleaning device 300 that can be used in conjunction with (or be part of) the central steam cleaning system 100. The portable cleaning device 300 can include a wand 302 and a cleaning head 304 connected to a distal end of the wand 302. The wand 302 can have a handle 310 which the operator can grip. The handle 310 can be connected to a proximal end of the wand 302. Although the wand 302 is depicted with a particular shape, it is to be understood that the wand 302 can have other shapes and/or dimensions in order to reach different areas (e.g., ceiling, stairs, countertops, etc.) for cleaning. In some examples, the wand 302 can be extendable.

The portable cleaning device 300 can include a water channel 306 and a vacuum channel 308. In some examples, the vacuum channel 308 can extend through a lumen of the wand 302 and into the cleaning head 304. In some examples, the water channel 306 can extend along (and side-by-side with) the wand 302.

The vacuum channel 308 can have a distal opening 328 located at the end of the cleaning head 304 and a proximal port 318. The proximal port 318 can be configured to be releasably connected to the first end 218 of the vacuum hose 208. Various coupling mechanisms (e.g., threads, clips, etc.) can be employed to couple the proximal port 318 to the first end 218.

The water channel 306 can have a distal opening 326 (e.g., a nozzle) and a proximal port 316. Water steam can be ejected or sprayed out of the distal opening 326. The proximal port 316 can be configured to be releasably connected to the first end 216 of the water hose 206. Various coupling mechanisms (e.g., threads, clips, etc.) can be employed to couple the proximal port 316 to the first end 216. In some examples, the portable cleaning device 300 can further include a control valve 312 connected to the water channel 306. The control valve 312 can be manually controlled by the operator to enable or disable water steam flow within the water channel 306, thereby controlling release of the water steam from the distal opening 326. For example, the control valve 312 can be a lever, which can be pulled in (toward the wand 302) to release the water steam.

Although in the above discussions, the portable cleaning device 300 is a separate entity from the hose assembly 200, in other examples, the hose assembly 200 can be an integral part of the portable cleaning device 300 (for example, the portable cleaning device 300 can have a built-in water hose and a built-in vacuum hose).

In some examples, the portable cleaning device 300 can be configured as a small hand-held attachment (e.g., without the wand 302) to the hose assembly 200. For example, the hand-held attachment can have a steam port (similar to the distal opening 326 of the water channel 306), which can be directly (and releasably) connected to the first end 216 of the water hose 206. The hand-held attachment can also have a vacuum port (similar to the distal opening 328 of the vacuum channel 308), which can be directly (and releasably) connected to the first end 218 of the vacuum hose 208. The hand-held attachment can further have a control valve (similar to the control valve 312) configured to enable or disable water steam to flow from the water hose 206 through and out of the steam port. In some examples, the hand-held attachment can be configured for cleaning a target area, such as a carpet, upholstery, seat, floor mat, trunk surface, dashboard, console, or other interior or exterior surface of a vehicle, building, or other structure or object.

In some examples, the portable cleaning device 300 can be optional. For example, the first end 218 of the vacuum hose 208 can be used as a vacuum head to directly to vacuum a spot to be cleaned, and the first end 216 of the water hose 206 can be configured to spray or eject water steam onto the spot to be cleaned. A control valve (similar to the control valve 312) can be mounted adjacent the first end 216 of the water hose 206 to enable or disable releasing of the water steam from the water hose 206.

### Example Steam Cleaning Methods

Example methods of steam cleaning using the above central steam cleaning systems are described herein. The methods can be used to clean target areas within a building, outside a building, and/or in areas associated with a building, such as vehicle cleaning areas.

In some examples, the central control unit 102 can be actuated, e.g., by turning on the engine 182 to power the pump 184 and the blower 190 so as to generate a sufficiently high negative pressure or vacuum within the vacuum pipeline 108 and a hot water steam with a sufficiently high temperature within the water pipeline 106.

In certain examples, air valves 132 and water valves 130 in the floor ports 120 located in certain floors of the building can be shut off so as to increase the negative pressure and water pressure in other floors.

In certain examples, the hose assembly 200 can be connected to one of the floor ports (e.g., for cleaning the hallways) and/or the room ports (e.g., for cleaning individual rooms). Specifically, the second end 228 of the vacuum hose 208 can be connected to the air adaptor 128 or 148, and the second end 226 of the water hose 206 can be connected to the water adaptor 126 or 146. As a result, negative pressure can be generated within the vacuum hose 208 and the hot water steam can flow into the water hose 206.

In some examples, the portable cleaning device 300 can be connected to the hose assembly 200. Specifically, the proximal port 316 of the water channel 306 can be connected to the first end 216 of the water hose 206, and the proximal port 318 of the vacuum channel 308 can be connected to the first end 218 of the vacuum hose 208. As a result, the negative pressure can be generated within the vacuum channel 308 and the hot water steam can flow into the water channel 306.

Then, the operator can move the portable cleaning device 300 (coupled to the hose assembly 200 with a sufficient length) around the hallways or rooms for cleaning. Specifically, the operator can release or spray the hot water steam from the distal opening 326 of the water channel 306 (e.g., by controlling the control valve 312). The released hot water steam can loosen dirt or debris on target areas. The negative pressure in the vacuum channel 308 can simultaneously suck up the loosened-up dirt or debris, which can pass through the vacuum hose 208 and the vacuum pipeline 108 before being deposited into the waste reservoir.

In some examples, use of the centralized steam cleaning system can be authorized through a kiosk or other payment terminal. The kiosk can receive a payment authorization and, in response to the payment authorization, can cause one or more valves associated with an access port to open. Opening the one or more valves can enable flow of water steam through an outlet of the water pipeline and/or enable application of air under negative pressure through an outlet of the vacuum pipeline. In some examples, the kiosk can authorize use of a selected access port for a predetermined cleaning session and can cause the one or more valves to close after expiration of the predetermined cleaning session.

### Example Exterior Centralized Steam Cleaning System

FIG. 9 depicts an example centralized steam cleaning system 400 configured for use in an exterior area associated with a building 410. The system 400 can include a pipe network 404 distributed across one or more areas of the building 410. In the illustrated example, at least a portion of the pipe network 404 is distributed outside the building 410. For example, the pipe network 404 can extend along or across a parking lot, driveway, vehicle service area, vehicle cleaning area, exterior walkway, courtyard, or other exterior area associated with the building 410.

The pipe network 404 can include a water pipeline 406 and a vacuum pipeline 408 that extend alongside each other. The water pipeline 406 can be configured to convey water steam, heated water, detergent, sanitizer, disinfectant, cleaning solution, or combinations thereof. The vacuum pipeline 408 can be configured to convey air under negative pressure. In some examples, the pipe network 404 can be connected to a central control unit, such as the central control unit 102 described above, which can generate the water steam within the water pipeline 406 and generate the negative pressure within the vacuum pipeline 408.

The system 400 can include a manifold 430 located outside the building 410. In some examples, the manifold 430 can be connected to the building 410. In other examples, the manifold 430 can be spaced apart from the building 410. The manifold 430 can be connected to the pipe network 404 and to one or more access ports 420. The manifold 430 can include one or more support posts 434. The support posts 434 can support at least a portion of the pipe network 404, one or more access ports 420, and/or one or more hose assemblies 450. In some examples, the support posts 434 can also be connected to or otherwise support one or more kiosks 440. In other examples, the kiosks 440 can be detached from the support posts 434. In some examples, one or more portions of the pipe network 404 can be secured to the manifold 430 and/or the support posts 434 by zip ties, clamps, brackets, straps, clips, fasteners, sleeves, pipe hangers, adhesives, or combinations thereof.

In some examples, the manifold 430 can include a vacuum conduit 432 supported by the one or more support posts 434. The vacuum conduit 432 can comprise a PVC pipe, metal pipe, polymer pipe, flexible conduit, rigid conduit, or another conduit suitable for conveying air under negative pressure. In some examples, the vacuum conduit 432 can define at least a portion of the vacuum pipeline 408. For example, the vacuum conduit 432 can be connected to and in fluid communication with one or more vacuum hoses 454. In other examples, the vacuum pipeline 408 can be defined at least in part by interconnected vacuum hoses 454, with or without a separate rigid vacuum conduit 432.

In some examples, the manifold 430 can include a water conduit 436 supported by the one or more support posts 434. The water conduit 436 can extend alongside the vacuum conduit 432. The water conduit 436 can comprise a conduit suitable for conveying high-temperature water steam, heated water, detergent, sanitizer, disinfectant, cleaning solution, or combinations thereof. For example, the water conduit 436 can comprise a metal pipe, a high-temperature-rated polymer pipe, a high-temperature-rated hose, or another steam-rated conduit. In some examples, the water conduit 436 can define at least a portion of the water pipeline 406. For example, the water conduit 436 can be connected to and in fluid communication with one or more water hoses 452. In other examples, the water pipeline 406 can be defined at least in part by interconnected water hoses 452, with or without a separate water conduit 436.

A water hose 452 and a vacuum hose 454 can together form a hose assembly 450, which can be similar to the hose assembly 200 described above. In some examples, each hose assembly 450 can extend along a corresponding support post 434. In some examples, the hose assembly 450 can be secured to the corresponding support post 434 by zip ties, clamps, brackets, straps, clips, fasteners, sleeves, pipe hangers, adhesives, or combinations thereof. In some examples, each hose assembly 450 can be releasably connected to a corresponding access port 420. In other examples, at least a portion of the hose assembly 450 can remain connected to the access port 420 during normal operation.

The system 400 can include a plurality of access ports 420 connected to the pipe network 404. Each access port 420 can include an outlet (similar to the water adaptor 126 or 146) of the water pipeline 406 and an outlet (similar to the air adaptor 128 or 148) of the vacuum pipeline 408. Each access port 420 can also include a housing 422 enclosing the outlet of the water pipeline 406 and the outlet of the vacuum pipeline 408. In some examples, a connection point between the vacuum conduit 432 and a vacuum hose 454 can be located within an access port 420, and/or a connection point between the water conduit 436 and a water hose 452 can be located within the access port 420. The housing 422 can comprise a cabinet, box, casing, enclosure, weather-resistant enclosure, lockable enclosure, or other structure configured to protect the outlets, valves, adaptors, control components, and/or connection points of the access port 420.

In some examples, an access port 420 can be configured as a pass-through access port 420a. In a pass-through access port 420a, the water pipeline 406 and the vacuum pipeline 408 can extend from a first side of the housing 422 to a second side of the housing 422. The pass-through access port 420a can be similar to the floor port 120 described above with respect to FIG. 3, except that the pass-through access port 420a can be located outside the building 410, mounted to a support post 434, connected to the manifold 430, or otherwise arranged in an exterior area.

In some examples, an access port 420 can be configured as a terminal access port 420b. In a terminal access port 420b, the water pipeline 406 and the vacuum pipeline 408 can extend into the housing 422 and not exit from the housing 422. The terminal access port 420b can be similar to the room port 140 described above with respect to FIGS. 4A-4B, except that the terminal access port 420b can be located outside the building 410, mounted to a support post 434, connected to the manifold 430, or otherwise arranged in an exterior area. Thus, the exterior system 400 can include one or more pass-through access ports 420a, one or more terminal access ports 420b, or combinations thereof.

One or more access ports 420 can include one or more valves enclosed within the housing 422. For example, the one or more valves can include a water valve configured to enable or disable flow of water steam through the outlet of the water pipeline 406, similar to the water valve 130 described above with respect to FIG. 3 and/or the water valve 150 described above with respect to FIGS. 4A-4B. The one or more valves can also include an air valve configured to enable or disable application of air under negative pressure through the outlet of the vacuum pipeline 408, similar to the air valve 132 described above with respect to FIG. 3. In some examples, a single access port 420 can include both the water valve and the air valve. In other examples, the access port 420 can include only one of the water valve or the air valve, or can include another valve arrangement configured to control access to water steam and/or negative pressure.

The system 400 can include one or more kiosks 440. A kiosk 440 can be configured to receive a payment authorization for use of the system 400. The payment authorization can include a credit card payment, debit card payment, mobile payment, account-based authorization, code-based authorization, subscription authorization, or another authorization. In response to receiving the payment authorization, the kiosk 440 can cause one or more valves associated with an access port 420 to open. Opening the one or more valves can enable access to the outlet of the water pipeline 406 and the outlet of the vacuum pipeline 408.

The kiosk 440 can be in wired or wireless communication with the one or more valves. For example, the kiosk 440 can communicate with a controller, actuator, solenoid, relay, motor, or other valve-control component located within or near the housing 422 of an access port 420. In some examples, each access port 420 can have a corresponding kiosk 440. In other examples, a single kiosk 440 can communicate with and control multiple access ports 420. In further examples, multiple kiosks 440 can communicate with a shared controller configured to control multiple access ports 420.

The system 400 can include a handheld cleaning device 460. The handheld cleaning device 460 can be similar to the portable cleaning device 300 described above, except that an elongated wand (e.g., 302) may be optional for the handheld cleaning device 460. For example, the handheld cleaning device 460 can include a water channel and a vacuum channel similar to the water channel 306 and the vacuum channel 308 described above with respect to FIG. 8. The water channel of the handheld cleaning device 460 can include a water or steam opening similar to the distal opening 326 and configured to release water steam toward a target area. The vacuum channel of the handheld cleaning device 460 can include a vacuum opening similar to the distal opening 328 and configured to apply air under negative pressure to the target area. The handheld cleaning device 460 can also include a control valve similar to the control valve 312 and configured to enable or disable flow of water steam through the water channel of the handheld cleaning device 460.

In use, the kiosk 440 can receive a payment authorization and cause one or more valves associated with an access port 420 to open, thereby enabling water steam to flow through the outlet of the water pipeline 406 and enabling air under negative pressure to be applied through the outlet of the vacuum pipeline 408. A user can release the water steam from the handheld cleaning device 460 toward a target area and apply the air under negative pressure to the target area through the handheld cleaning device 460. The target area can include a vehicle carpet, vehicle seat, vehicle upholstery, floor mat, trunk surface, building surface, outdoor surface, or another surface to be steam cleaned.

Although FIG. 9 depicts an exterior example, the features described with reference to FIG. 9 can be combined with any of the features described with reference to FIGS. 1-8. For example, an exterior access port 420 can include adaptors, seals, valves, caps, hoses, or coupling structures similar to those described above with respect to the floor port 120, room port 140, hose assembly 200, and portable cleaning device 300.

The technologies from any example can be combined with the technologies described in any one or more of the other examples. In view of the many possible examples to which the principles of the disclosed technology can be applied, it should be recognized that the illustrated embodiments are examples of the disclosed technology and should not be taken as a limitation on the scope of the disclosed technology. Rather, the scope of the claimed subject matter is defined by the following claims and their equivalents.

We claim:

1. A centralized steam cleaning system comprising:
a central control unit;
a pipe network connected to the central control unit; and
a plurality of access ports connected to the pipe network,
wherein the pipe network is distributed across one or more areas of a building,
wherein the pipe network comprises a vacuum pipeline and a water pipeline that extend alongside each other,
wherein the central control unit is configured to generate a negative pressure for air within the vacuum pipeline and a water steam within the water pipeline,
wherein each access port comprises an outlet of the water pipeline and an outlet of the vacuum pipeline,
wherein each access port comprises a housing enclosing the outlet of the water pipeline and the outlet of the vacuum pipeline.

2. The centralized steam cleaning system of claim 1, wherein the negative pressure is between 6 psi and 9 psi, and wherein the water steam has a temperature ranging between 200 degrees Fahrenheit and 240 degrees Fahrenheit.

3. The centralized steam cleaning system of claim 1, wherein the pipe network is at least partially distributed within the building.

4. The centralized steam cleaning system of claim 1, wherein the pipe network is at least partially distributed outside the building.

5. The centralized steam cleaning system of claim 4, wherein at least one of the access ports comprises an exterior access port located outside the building.

6. The centralized steam cleaning system of claim 1, wherein at least one of the access ports comprises an air valve and a water valve enclosed within the housing of the at least one access port, wherein the air valve is configured to enable or disable air flow through the outlet of the vacuum pipeline, and wherein the water valve is configured to enable or disable flow of the water steam through the outlet of the water pipeline.

7. The centralized steam cleaning system of claim 1, wherein at least one of the access ports comprises a pass-through access port in which the water pipeline and the vacuum pipeline extend from a first side of the housing to a second side of the housing.

8. The centralized steam cleaning system of claim 1, wherein at least one of the access ports comprises a terminal access port in which the water pipeline and the vacuum pipeline extend into the housing and do not exit from the housing.

9. The centralized steam cleaning system of claim 1, further comprising a hose assembly, wherein the hose assembly comprises a water hose and a vacuum hose, wherein the water hose is configured to be releasably connected to the outlet of the water pipeline, and wherein the vacuum hose is configured to be releasably connected to the outlet of the vacuum pipeline.

10. The centralized steam cleaning system of claim 9, wherein the outlet of the water pipeline comprises a seal configured to block the water steam within the water pipeline from escaping through the outlet of the water pipeline, and wherein connecting the water hose to the outlet of the water pipeline is configured to displace the seal so as to enable the water steam within the water pipeline to escape through the outlet of the water pipeline.

11. A centralized steam cleaning system comprising:
a pipe network distributed across one or more areas of a building, wherein the pipe network comprises a vacuum pipeline and a water pipeline that extend alongside each other; and
a plurality of access ports connected to the pipe network, wherein each access port comprises an outlet of the water pipeline and an outlet of the vacuum pipeline,
wherein the water pipeline is configured to allow a water steam to flow therethrough, wherein the vacuum pipeline is configured to allow air under negative pressure to flow therethrough,
wherein the plurality of access ports comprises one or more pass-through access ports, wherein each pass-through access port comprises a housing enclosing the outlet of the water pipeline and the outlet of the vacuum pipeline, and
wherein the water pipeline and the vacuum pipeline extend through the housing of each pass-through access port.

12. The centralized steam cleaning system of claim 11, further comprising a central control unit configured to generate the negative pressure for the air within the vacuum pipeline and the water steam within the water pipeline.

13. The centralized steam cleaning system of claim 11, further comprising a hose assembly, wherein the hose assembly comprises a water hose and a vacuum hose, wherein the water hose is configured to be releasably connected to the outlet of the water pipeline, and wherein the vacuum hose is configured to be releasably connected to the outlet of the vacuum pipeline.

14. The centralized steam cleaning system of claim 11, further comprising a manifold located outside the building, wherein the manifold is connected to the pipe network and to the one or more pass-through access ports.

15. The centralized steam cleaning system of claim 14, wherein the manifold comprises one or more support posts and a vacuum conduit defining a portion of the vacuum pipeline and supported by the one or more support posts.

16. The centralized steam cleaning system of claim 11, further comprising a kiosk configured to receive a payment authorization and, in response to the payment authorization, cause one or more valves to open to enable access to the outlet of the water pipeline and the outlet of the vacuum pipeline of one of the access ports.

17. The centralized steam cleaning system of claim 11, wherein the plurality of access ports comprises one or more floor ports, and wherein, for each floor port, the water pipeline and the vacuum pipeline extend through the housing.

18. The centralized steam cleaning system of claim 11, wherein the plurality of access ports comprises one or more room ports, and wherein, for each room port, the water pipeline and the vacuum pipeline extend into the housing and do not exit from the housing.

19. A method comprising:
causing water steam to flow through a water pipeline of a pipe network distributed across one or more areas of a building;
causing air under negative pressure to flow through a vacuum pipeline of the pipe network, wherein the vacuum pipeline and the water pipeline extend alongside each other;
enabling flow of the water steam through an outlet of the water pipeline at an access port connected to the pipe network;
enabling application of the air under negative pressure through an outlet of the vacuum pipeline at the access port;
releasing the water steam from the outlet of the water pipeline toward a target area; and
applying the air under negative pressure from the outlet of the vacuum pipeline to the target area,
wherein the access port comprises a housing enclosing the outlet of the water pipeline and the outlet of the vacuum pipeline.

20. The method of claim 19, further comprising receiving, by a kiosk, a payment authorization and, in response to receiving the payment authorization, opening one or more valves to enable flow of the water steam through the outlet of the water pipeline and to enable application of the air under negative pressure through the outlet of the vacuum pipeline.
